(19) United States
(12) Patent Application Publication
(10) Pub. No.: US 2007/0165582 A1
(43) Pub. Date: Jul. 19, 2007

(54) System and method for authenticating a wireless computing device

(76) Inventor: Puneet Batta, Santa Clara, CA (US)

Correspondence Address: FAY KAPLUN & MARCIN, LLP, 15O BROADWAY, SUITE 702, NEW YORK, NY, 10038, US

(21) Appl. No.: 11/334,648

(22) Filed: Jan. 18, 2006

(51) Int. Cl. H04Q 7/24

(52) U.S. Cl. 370/338

(57) ABSTRACT

Described is a method, comprising receiving an authentication request by a server from a first wireless device, the authentication request including request data corresponding to a second wireless device. The second wireless device is authenticated by the server as a function of the request data. The server generates authentication data as a function of the request data. The server transmits the authentication data to the first wireless device so that the first wireless device authenticates the second wireless device using the authentication data upon receipt of a further authentication request from the second wireless device.

### FIELD OF INVENTION

The present invention relates to wireless communications and, in particular, to a system and method for authenticating a wireless computing device.

### BACKGROUND INFORMATION

In a conventional communications network, access to the network is often restricted to authorized users. A user inputs a username and/or a password into a computing device which is coupled to an authentication server via an authenticator (e.g., an access point/port, (“AP”)). The authentication server executes an authentication procedure using the username and/or the password and determines whether to grant access to the network. The authentication procedure includes authentication schemes such as IEEE 802.1x. In order for the authentication server to authenticate the user, communication between the authenticator and the authentication server must be maintained. However, this is not always possible because, for example, communication between the authenticator and the authentication server is occasionally interrupted.

When communication between the authenticator and the authentication server is interrupted or the computing device roams to another AP, the authentication procedure is executed again to confirm the identity of the user. Also, when the user engages in a data transaction which requires user credentials (e.g., the username/password), or simply wishes to maintain a connection to the communications network, the authentication procedure may be performed again. The communication interruption requires the user's computing device to re-authenticate continually. Therefore, there is a need for a system and a method which allow re-authentication to occur despite communication interruptions.

### SUMMARY OF THE INVENTION

The present invention relates to a system and method for authenticating a wireless device. The method comprises receiving an authentication request by a server from a first wireless device, the authentication request including request data corresponding to a second wireless device. The second wireless device is authenticated by the server as a function of the request data. The server generates authentication data as a function of the request data. The server transmits the authentication data to the first wireless device so that the first wireless device authenticates the second wireless device using the authentication data upon receipt of a further authentication request from the second wireless device.

### BRIEF DESCRIPTION OF THE DRAWINGS

FIG. 1 shows an exemplary embodiment of a system according to the present invention;

FIG. 2 shows an exemplary embodiment of a method according to the present invention; and

FIG. 3 shows an exemplary embodiment of another method according to the present invention.

### DETAILED DESCRIPTION

The present invention may be further understood with reference to the following description and the appended drawings, wherein like elements are referred to with the same reference numerals. The present invention describes a system and a method for authenticating a wireless computing device (e.g., a mobile unit, (“MU”)) in a wireless network. Although the present invention will be described with respect to the wireless network, those of skill in the art will understand that the present invention may be implemented in any wired or wireless network and/or subnetwork in which computing devices are authenticated prior to receiving access to the network.

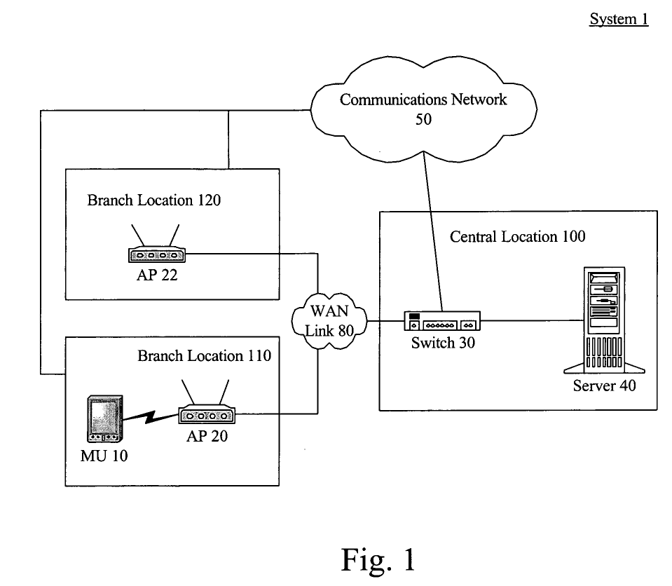

FIG. 1 shows an exemplary embodiment of a system 1 according to the present invention. The system 1 may be implemented as a distributed system with, for example, a central location 100 (e.g., a main office, a retail headquarters, etc.) and one or more branch locations 110 and 120 (e.g., a branch office, a retail store, etc.). The central location 100 may include networking devices such as a server 40, which may be coupled to a network management arrangement (e.g., switch 30). Each of the branch locations 110, 120 may include one or more access points/ports (“APs”), which provide access to a communications network 50 (e.g., the Internet) and the server 40 via a wide-area network (“WAN”) link 80 to the switch 30. For example, the branch location 110 may include an AP 20 in communication with an MU 10. As understood by those of skill in the art, the WAN link 80 may be required for communication between the MU 10 and/or the AP 20 and the server 40. Although FIG. 1 shows the switch 30 as located in the central location 100, those of skill in the art will understand that the switch 30 may be located at each of the branch locations 110, 120 and provide access to the WAN link 80.

The APs 20, 22 provide wireless connections for the MU 10 to the communications network 50 and to the server 40. Each AP 20, 22 includes a radio-frequency (“RF”) arrangement such as a transceiver allowing the AP 20, 22 to communicate wireless signals with the MU 10 according to a wireless communications protocol (e.g., an IEEE 802.1x protocol). The APs 20, 22 may include additional hardware and/or software (e.g., a processor and a memory arrangement) for use in communications and authentication, which will be described below.

The MU 10 may be any mobile computing device (e.g., a laptop, a cell phone, a laser-/image-based scanner, an RFID reader/tag, a network interface card, a PDA, a handheld computer, etc.) which includes an RF communications arrangement (e.g. a transceiver) allowing for communication of wireless signals in accordance with the wireless communications protocol.

The communications network 50 may be a wired and/or a wireless network which includes one or more network computing devices such as servers, routers, switches, etc. The communications network 50 may be connected to other communications networks, such as the Internet, a local-area network (“LAN), etc.

The server 40 may be an authentication server (e.g., a remote authentication dial-in user service, (“RADIUS”) server) which authenticates remote devices and upon authentication, fulfills data requests from those devices. For example, the server 40 may receive an authentication request from the MU 10 in accordance with an extensible authentication protocol (“EAP”) method. The EAP method may utilize a transport layer security (“TLS”) protocol to establish a secure communication channel between the MU 10 and the server 40. The server 40 may include hardware and/or software components for servicing the authentication request, such as a processor for executing instructions, a memory for storing instructions and/or data, and a networking arrangement (e.g., a network interface card, a modem, etc.) for communicating with the APs 20,22 via the WAN link 80.

The WAN link 80 may be a direct cable connection (e.g., an Ethernet cable) between the server 40 and the switch 30 or an indirect connection which includes one or more computing devices (e.g., a server, a router, a switch, etc.) or networks (e.g., the Internet).

The switch 30 may be a wireless switch which includes hardware and/or software to facilitate communication between devices connected thereto. The switch 30 may allow the MU 10 to access the communications network 50 and/or the server 40.

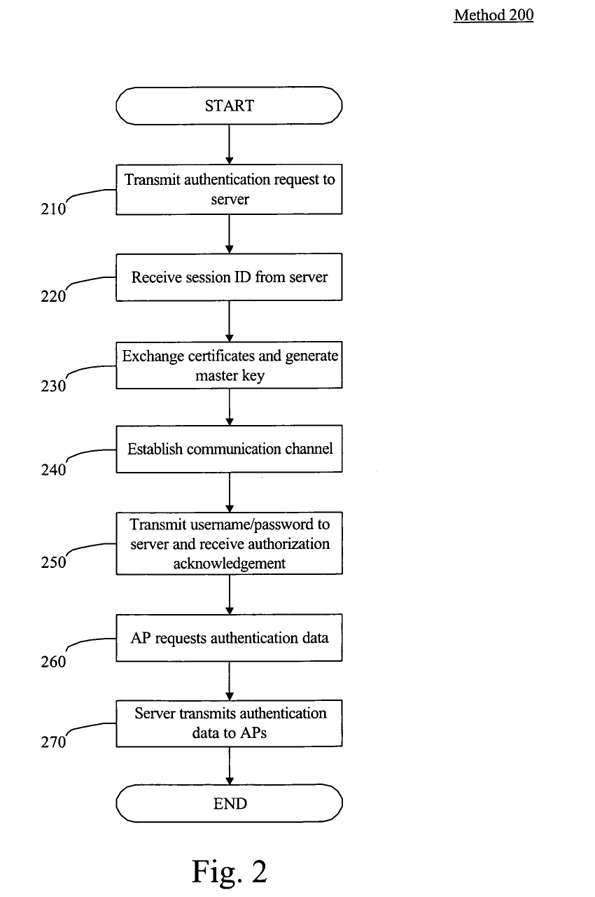

FIG. 2 shows an exemplary embodiment of a method 200 according to the present invention. In step 210, the MU 10 transmits an authentication request to the server 40. The authentication request may be transmitted when the MU 10 establishes an initial communication session with the server 40. This may occur when the MU 10 is powered on, when a user of the MU 10 desires access to resources on the communications network 50 or the server 40, etc. The authentication request is initially received by and transmitted to the server 40 from the AP 20. The AP 20 prevents the MU 10 from accessing the communications network 50 until the authentication succeeds.

In step 220, the MU 10 receives a session ID from the server 40. The session ID may be a random or pseudo-random number generated by the server 40 when the authentication request is received. The session ID serves as a unique identifier for the initial communication session, between the server 40 and the MU 10.

In step 230, the MU 10 exchanges security certificates with the server 40 and a master security key is generated using encryption keys included in the security certificates. For example, a pre-master security key may have been randomly generated by the MU 10 and encrypted using a public encryption key corresponding thereto. The pre-master security key may then have been decrypted by the server 40 using the public encryption key. Both the MU 10 and the server 40 may then generate the master security key by applying a common algorithm upon the pre-master security key.

In step 240, a communication channel is established between the MU 10 and the server 40. This may occur as a result of the MU 10 transmitting an acknowledgment to the server 40, indicating a desire to engage in secure communications.

In step 250, the MU 10 transmits user identification data (e.g,. the username and/or the password) to the server 40 via the communication channel. The user identification data may be encrypted prior to transmission. The MU 10 then receives an authorization acknowledgment from the server 40. For example, if the user identification data is authenticated by the server 40, the username and/or the password may be compared against a user database accessible by the server 40.

In step 260, after the MU 10 has been authenticated, the APs 20,22 request the authentication data from the server 40. The APs 20, 22 may each transmit an authentication data request after transmitting the authorization acknowledgment to the MU 10, which was received in step 250.

In step 270, the server 40 transmits the authentication data to the APs 20, 22. The authentication data may include information associated with the initial communication session, such as the master security key, the session ID, and a hash of the user identification data. As will later be discussed, this information may be utilized to re-authenticate the user without having to repeat the method 200. The authentication data may be stored at the APs 20, 22 until a removal condition occurs. The removal condition may be when the AP reaches a predetermined storage capacity. For example, each AP 20, 22 may only have enough capacity to store the authentication data for a certain number of MUs. When the storage capacity is reached, the AP 20, 22 may delete older authentication data, allowing new authentication data to be stored (e.g., FIFO). The removal condition may also be time-based. For example, the authentication data may be automatically removed after a predefined time period based on, for example, a time elapsed since a last re-authentication, a total number of re-authentications, etc.

In other embodiments, the server 40 may only transmit the authentication data to the AP 20, or the authentication data may first be transmitted to the AP 20, then transmitted to the AP 22 at a later time. In yet further embodiments, the APs 20, 22 may save the authentication data as it is being transmitted to/from the MU 10. For example, in anticipation of a successful authentication, the AP 20 may save the session ID during step 220, the master security key during step 230, and the username/password during step 250.

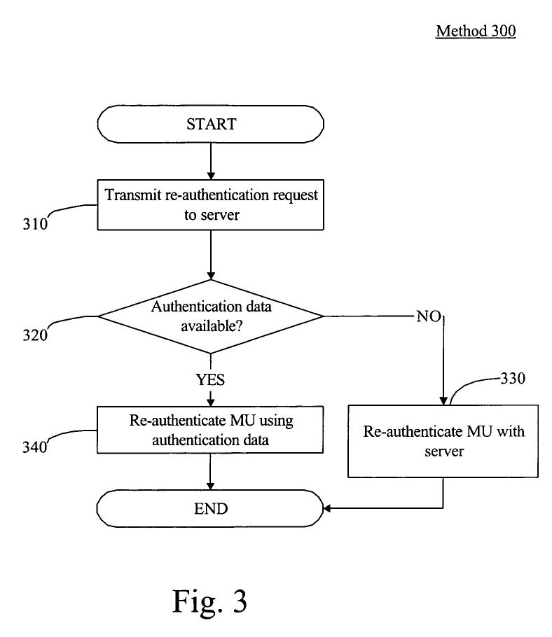

FIG. 3 shows an exemplary embodiment of a method 300 according to the present invention. The method 300 may be performed subsequent to successful authentication of the MU 10 by the server 40, and may be initiated when the MU 10 transmits a re-authentication request to the server 40. As would be known to those skilled in the art, re-authentication may be required for various reasons when the MU 10 is in use. For example, the MU 10 may initiate communication with a different AP when roaming. Another reason for re-authenticating may be a discontinuation of the initial communication session. For example, the WAN link 80 may be terminated, causing the MU 10 to lose its connection to the network 50. Accordingly, in step 310 the MU 10 transmits the re-authentication request to the server 40 in a manner similar to that of step 210 in the method 200.

In step 320, an AP receiving the re-authentication request determines if the authentication data is available. If the MU 10 is performing the roaming operation, the AP may be the AP 22. Alternatively, if the MU 10 is attempting to reestablish the initial communication session, the authenticating AP may be the AP 20.

In step 330, the authentication data is not available, and the MU 10 must re-authenticate with the server 40 in a manner similar to that used to establish the initial communication session. Thus, the method 200 may be repeated in its entirety. Alternatively, the method 200 may be repeated without executing steps 260 and 270.

In step 340, the authentication data is available, and the MU 10 is re-authenticated. As known to those skilled in the art, the TLS protocol supports session resumption. Therefore, the AP 20 may utilize the authentication data to resume the initial communication session without requiring a full handshake sequence (e.g., exchange of certificates, generation of security keys, etc.) with the server 40. This may be accomplished by, for example, performing a test to determine the validity of the authentication data. Thus, the MU 10 may then re-authenticate directly with the AP 20 through a method such as password authentication protocol (“PAP”). The MU 10 supplies the username and/or the password, and is immediately authenticated because the AP 20 has the hash of the user identification data. The AP 20 then provides the MU 10 with access to the communications network 50. Additionally, the authenticating AP may terminate the communication channel.

The present invention provides several advantages over the conventional authentication method. By removing dependence on the WAN link 80, the AP 20 may authenticate the MU 10. Thus, if communication between the MU 10 and the server 40 is interrupted (e.g., the server 40 is taken off-line, the WAN link 80 is terminated, etc.), the MU 10 can re-authenticate, maintaining access to the communications network 50. In addition, re-authentication is made faster because data is no longer passed between the MU 10 and the server 40 during the re-authentication. This may be particularly advantageous if the MU 10 is performing the roaming operation, since re-authentication delay could be perceived as an interruption in service.

It will also be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
receiving an authentication request by a server from a first wireless device, the authentication request including request data corresponding to a second wireless device;
authenticating the second wireless device by the server as a function of the request data;
generating authentication data by the server as a function of the request data;
transmitting the authentication data to the first wireless device so that the first wireless device authenticates the second wireless device using the authentication data upon receipt of a further authentication request from the second wireless device.

2. The method according to claim 1, wherein the further authentication request includes the request data.

3. The method according to claim 1, wherein the request data includes at least one of (i) a session identifier, (ii) a security key, (iii) a security certificate, and (iv) user identification data indicative of a user of the second wireless device.

4. The method according to claim 1, wherein the authenticating step includes the following substep:
comparing the request data to stored data in an authentication database.

5. The method according to claim 1, wherein the authentication data includes at least one of (i) a session identifier, (ii) a security key and (iii) a hash of user identification data indicative of a user of the second wireless device.

6. The method according to claim 1, further comprising:
establishing a communication session between the second wireless device and the server using a TLS protocol.

7. The method according to claim 1, further comprising:
upon receipt of the further authentication request, establishing a communication session between the first and second wireless devices using a PAP protocol.

8. The method according to claim 1, wherein the first wireless device includes at least one of a switch, an access point and an access port.

9. The method according to claim 1, wherein the second wireless device includes at least one of a laser-based scanner, an image-based scanner, an RFID reader, an RFID tag, a phone, a PDA, a tablet, a network interface card and a laptop.

10. The method according to claim 1, wherein the server is a RADIUS server.

11. The method according to claim 1, further comprising:
transmitting the authentication data to at least a third wireless device within a predetermined range of the second wireless device so that the at least the third wireless device authenticates the second wireless device upon receipt of the further authentication request.

12. A system, comprising:
a server;
a first wireless device communicatively coupled to the server; and
a second wireless communicatively coupled to the first wireless device, the second wireless device transmitting an authentication request to the server via the first wireless device, the authentication request including request data corresponding to the second wireless device,
wherein, the server authenticates the second wireless as a function of the request data, the server generating authentication data as a function of the request data, the server transmitting the authentication data to the first wireless device so that the first wireless device authenticates the second wireless device using the authentication data upon receipt of a further authentication request from the second wireless device.

13. The system according to claim 12, wherein the first wireless device includes at least one of a switch, an access point and an access port.

14. The system according to claim 12, wherein the second wireless device includes at least one of a laser-based scanner, an image-based scanner, an RFID reader, an RFID tag, a phone, a PDA, a tablet, a network interface card and a laptop.

15. The system according to claim 12, wherein the server is a RADIUS server.

16. The system according to claim 12, wherein the further authentication request includes the request data.

17. The system according to claim 12, wherein the request data includes at least one of (i) a session identifier, (ii) a security key, (iii) a security certificate, and (iv) user identification data indicative of a user of the second wireless device.

18. The system according to claim 12, wherein the authentication data includes at least one of (i) a session identifier, (ii) a security key and (iii) a hash of user identification data indicative of a user of the second wireless device.

19. The system according to claim 12, wherein the second wireless device and the server establish a communication session using a TLS protocol.

20. The system according to claim 12, wherein, upon receipt of the further authentication request, the first wireless device establishes a communication session with the second wireless devices using to a PAP protocol.

21. An arrangement, comprising:
a communication arrangement forwarding an authentication request from a wireless device to a server, the authentication request including request data corresponding to the wireless device, the communication arrangement receiving authentication data from the server, the authentication data indicative of an authentication of the wireless device by the server as a function of the request data;
a memory storing the authentication data;
a processor authenticating the wireless device upon receipt of a further authentication request from the wireless device.

22. The arrangement according to claim 21, wherein the arrangement is one of a switch, an access point and an access port.

23. An arrangement, comprising:
a communication means for forwarding an authentication request from a wireless device to a server, the authentication request including request data corresponding to the wireless device, the communication arrangement receiving authentication data from the server, the authentication data indicative of an authentication of the wireless device by the server as a function of the request data;
a storage means for storing the authentication data;
an authenticating means for authenticating the wireless device upon receipt of a further authentication request from the wireless device.
